(19) United States
(12) Patent Application Publication
(10) Pub. No.: US 2021/0071703 A1
(43) Pub. Date: Mar. 11, 2021

(54) NUT CAP

(71) Applicant: Novaria Holdings, LLC, North Richland Hills, TX (US)

(72) Inventor: Jimmy Wayne Mahaffey, Ravenden, AR (US)

(73) Assignee: Novaria Holdings, LLC, North Richland Hills, TX (US)

(21) Appl. No.: 17/012,869

(22) Filed: Sep. 4, 2020

Related U.S. Application Data
(60) Provisional application No. 62/896,246, filed on Sep. 5, 2019.

(51) Int. Cl. F16B 37/14; F16B 37/04; F16B 39/08

(52) U.S. Cl. CPC F16B 37/14; F16B 43/001; F16B 39/08; F16B 37/044

(57) ABSTRACT

A fastening system is disclosed. The fastening system may have a washer and a cap. The cap may attach to the washer to protect a bolt and/or a nut disposed at least partially inside a cavity of the cap. The cap may be at least partially conical. The cap may include a channel to receive a sealant to ameliorate leakage.

### CROSS-REFERENCE TO RELATED APPLICATIONS

This application claims the benefit of and priority to co-pending U.S. Prov. Pat. App. No. 62/896,246, filed on Sep. 5, 2019, and entitled “CONIC NUT CAP,” the disclosure of which is hereby incorporated by reference in its entirety.

### FIELD

The present disclosure relates generally to fasteners, and more specifically, to a cap to cover a nut and/or bolt.

### BACKGROUND

Frequently fasteners are used to join articles together. One such fastener may be a nut tightened along a bolt. Frequently the nut and/or protruding end of the bolt may be exposed to harsh elements, for instance moisture, chemicals, salt, etc. Moreover, the nut and/or protruding end of the bolt may contact proximate articles, such as wires passing nearby. In various instances, the exposure to harsh elements may wear, corrode, and/or rust the nut and/or bolt, causing weakness and/or difficulty loosening and/or fastening. Furthermore, nut and/or protruding end of the bolt may be desired to be electrically insulated from proximate articles. Yet also, contact between the nut and/or protruding end of the bolt and proximate articles may cause proximate articles, such as wires, to fray due to contact.

### SUMMARY

A washer is provided. The washer may include a main washer body having a plate defining an encircled aperture and extending radially outward to an outward edge. The main washer body may have a first surface and a second surface opposite the first surface such that the encircled aperture extends continuously from the first surface to the second surface. The washer may include an edge ring disposed about the outward edge of the washer and comprising an outward threaded face. The outward threaded face may have a face of the edge ring and threads configured to receive corresponding threads of an inner threaded face of a cap.

In various embodiments, the first surface may be continuous in a first plane and the second surface may be continuous in a second plane spaced apart from and parallel to the first plane. The main washer body may not include a counterbore in the first surface, and the main washer body may not include a counterbore in the second surface.

In various embodiments, the first surface may be continuous in a first plane and the second surface may be continuous in a second plane spaced apart from and parallel to the first plane, wherein both the first plane and the second plane are flat planes.

In various embodiments, the first surface may be continuous in a first plane and the second surface may be continuous in a second plane, wherein the first plane may be one of concave and convex. The second plane may be one of concave and convex.

In various embodiments, the first surface may be defined by a first continuous non-piecewise mathematic function and wherein the second surface may be defined by a second continuous non-piecewise mathematic function. The first and second surfaces may be parallel and spaced apart.

In various embodiments, the plate is annular. The face of the edge ring comprised of the outward threaded face may be a radially outermost face of the edge ring relative to the central longitudinal axis. The encircled aperture may be defined through a center of the main washer body. The washer may be threadably joinable to the cap and at least partially received into the cap.

In another embodiment, a cap is provided. The cap may have a primary member comprising a wall member and a floor member defining a conic section with an open end. The cap may have a skirt disposed adjacent the open end of the primary member. The cap may have an inner threaded face comprising a radially inward face of at least one of the skirt and the wall member and configured to receive the threads of an outward threaded face of a washer.

In various embodiments, the primary member may have a first diameter and the skirt has a second diameter larger than the first diameter.

In various embodiments, the cap may have a contact edge comprising an edge of the wall member of the primary member positioned opposite the floor member and configured to contact an article being joined by a combination of a nut and a bolt, wherein the cap at least partially encloses the nut. The contact edge may have an edge channel. The edge channel may have an annular groove defined in a face of the contact edge and forming a channel. The skirt may house the edge channel.

In various embodiments, the cap may have an aperture defined through the skirt, such that the aperture faces radially outward from the skirt and opens into the skirt parallel to a longitudinal axis of the cap.

In various embodiments, the cap may have an aperture disposed on an upper surface of the skirt, such that the aperture extends radially outward and faces open along a longitudinal axis of the cap.

In another embodiment, a fastening system is provided. The fastening system may have a washer and a cap. The washer may have a main washer body having a plate defining an encircled aperture configured to receive a bolt and extending radially outward to an outward edge. The washer may have an edge ring disposed about the outward edge of the washer and comprising an outward threaded face. The outward threaded face may have a face of the edge ring and comprises threads. The cap may have a primary member having a wall member and a floor member defining a conic section with an open end, such that the conic section defines a cavity. The cap may have a skirt disposed along the open end of the primary member. The cap may have an inner threaded face comprising a radially inward face of at least one of the wall member and the skirt and configured to receive corresponding threads of the outward threaded face of the washer. The cap may be configured to couple to the washer such that a portion of the bolt and a nut are inside the cavity of the cap and the washer at least partially closes the cavity.

In various embodiments, the plate may be annular. The face of the edge ring comprised of the outward threaded face may be a radially outermost face of the edge ring relative to the central longitudinal axis. The encircled aperture may be defined through a center of the main washer body. The wall member may have a first diameter and the skirt has a second diameter larger than the first diameter.

In various embodiments, the fastening system may have a contact edge of the skirt and encircling the open end of the primary member and an edge channel. The edge channel may have an annular groove defined in a face of the contact edge and forming a channel. The skirt may house the edge channel.

In various embodiments, the fastening system may have an aperture disposed on the skirt and providing a fluid passage through the skirt to the edge channel.

### BRIEF DESCRIPTION OF THE DRAWINGS

The subject matter of the present disclosure is particularly pointed out and distinctly claimed in the concluding portion of the specification. A more complete understanding of the present disclosure, however, is best be obtained by referring to the detailed description and claims when considered in connection with the drawing figures, wherein like numerals denote like elements.

FIG. 1 illustrates an isometric view of an example fastening system including a bolt, nut, washer, and cap, in accordance with various embodiments;

FIG. 2 illustrates a section view of an example fastening system including a bolt, nut, washer, and cap, in accordance with various embodiments;

FIG. 3 illustrates different example fastening systems of different sizes, in accordance with various embodiments;

FIG. 4 illustrates an example washer, in accordance with various embodiments;

FIG. 5 illustrates an example cap, in accordance with various embodiments;

FIG. 6 illustrates an isometric view of an example washer attached to an example cap, in accordance with various embodiments;

FIG. 7 illustrates a section view of an example washer attached to an example cap, in accordance with various embodiments;

FIG. 8 illustrates an example method of using a fastening system, in accordance with various embodiments;

FIG. 9 illustrates an isometric view of an example fastening system including a bolt, nut, washer, and cap, in accordance with various embodiments;

FIG. 10 illustrates a section view of an example fastening system including a bolt, nut, washer, and cap, in accordance with various embodiments;

FIG. 11 illustrates an example washer, in accordance with various embodiments;

FIGS. 12A-12B illustrate example dimensions of a washer, in accordance with various embodiments;

FIGS. 13A-C illustrate example caps, in accordance with various embodiments; and

FIGS. 14A-14G illustrate example dimensions of a cap, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice embodiments of the disclosure, it should be understood that other embodiments may be realized and that logical changes and adaptations in design and construction may be made in accordance with this invention and the teachings herein. Thus, the detailed description herein is presented for purposes of illustration only and not limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Furthermore, any reference to singular includes plural embodiments, and any reference to more than one component or step may include a singular embodiment or step. Surface shading lines may be used throughout the figures to denote different parts but not necessarily to denote the same or different materials.

To be oriented “outward” of an object means having a position farther from a shared reference point than the object. For example, to be outward of a longitudinal axis relative to an object means having a distance from the longitudinal axis, a lateral vector component of which is greater than that of a corresponding lateral vector component of the distance of the object from the shared longitudinal axis.

Similarly, as used herein a “direction” and an “opposing direction” comprise directions having a vector component extending at least partially in opposite directions, such as wherein the statement pointing in a “first direction” means having a vector component extending at least partially opposite an “opposing second direction.”

Finally, as used herein “forward” and “aft” may describe relative positions along a longitudinal axis relative to another object. As used herein, forward means toward to an extreme distal end of a threaded portion of the bolt, whereas aft means the opposite of forward. For example, a nut is typically forward of a washer when attached to a bolt, whereas a washer is typically aft of a nut when attached to a bolt.

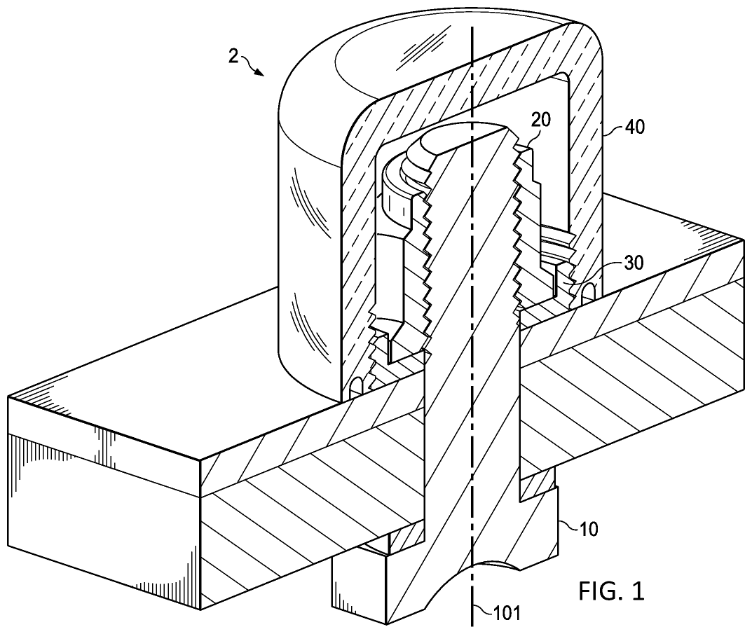

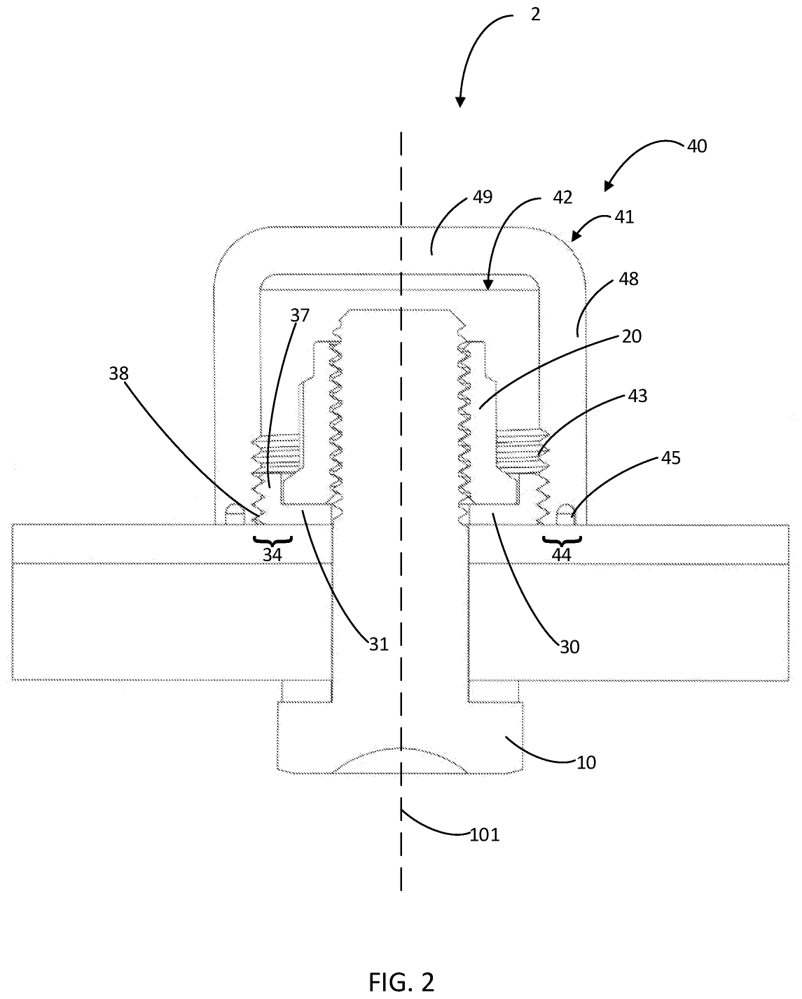

With reference to FIGS. 1 and 2, a fastening system 2 is provided. The fastening system 2 comprises a combination of fastening elements configured to join at least two articles together. The fastening system 2 may include a bolt 10 and a nut 20 that can thread onto a threaded portion of the bolt 10, sandwiching articles to be joined along the length of the bolt 10.

The fastening system 2 may include a washer 30. The washer 30 may be placed between the nut 20 and an article being loaded in compression by the combination of bolt 10 and nut 20. The washer 30 may increase the contact area of the nut 20 in conjunction with the article. The fastening system 2 may also include a cap 40. The cap 40 may comprise a protective aspect. For instance, the cap 40 may define a cavity sized to receive at least a portion of a nut 20 and or bolt 10 and may be joinable to the washer 30. For instance, the cap 40 may be closed on all but one size, and the one open side may be threadably connectable to the washer 30, wherein an internal cavity of the cap 40 is closed. The fastening system 2 may have a washer 30 attachable to a cap 40 configured to enclose at least a portion of a nut 20 and/or bolt 10.

A shared central longitudinal axis 101 may align with a center of an aperture of the nut 20 and/or the central axis of the bolt 10, and/or a center of an aperture of the washer 30, and may extend longitudinally through the center of the bolt 10, nut 20, washer 30, and cap 40.

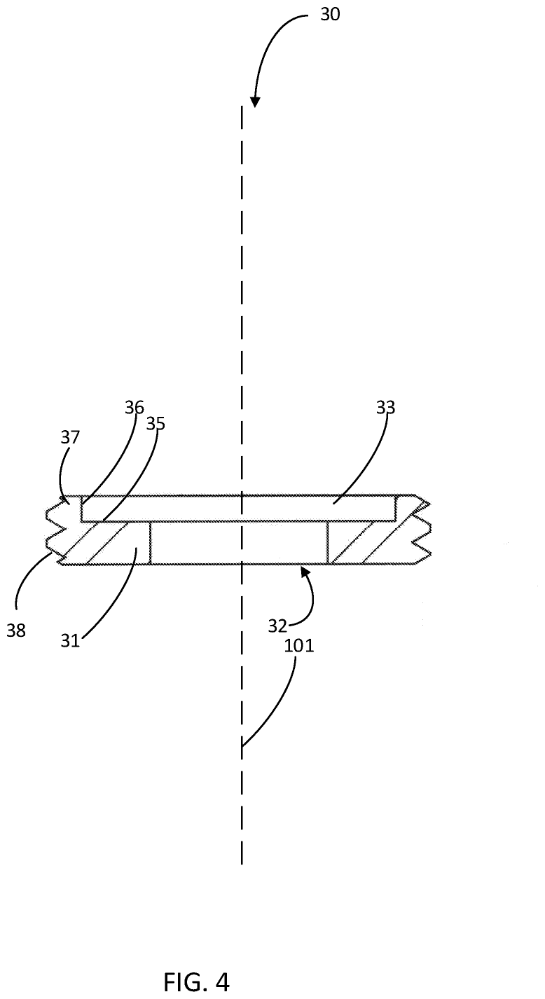

Turning now to FIGS. 2 and 4, specific aspects of the washer 30 are now introduced. A washer 30 may comprise an annular member compressible between a nut 20 and an object joined in compressive loading to the combination of nut 20 and bolt 10. The washer 30 may be an annulus, or in further embodiments, may have different shapes as desired.

Washer 30 may include a main washer body 31. A main washer body 31 comprises a primary flange of the washer 30. The main washer body 31 may comprise an annular plate, for instance, resembling a flat donut, though further shapes may be contemplated. A bolt channel 32 may comprise an aperture defined through the main washer body 31. In various instances, the bolt channel 32 is aligned centered on a central longitudinal axis 101 during use, the central longitudinal axis 101 extending normal to the main washer body 31 through a center of the bolt channel 32. Thus one may say that the main washer body 31 comprises an annular plate defining an encircled aperture (bolt channel 32) and extending radially outward to an outward edge (e.g., extending to edge ring 34).

Washer 30 may include a washer counterbore 33. A washer counterbore 33 may include a cavity disposed in the washer 30 and configured to receive at least a portion of the nut 20 therein. For instance, the washer counterbore 33 may include a floor 35 and a lip 36. The floor 35 may comprise a face contactable to the nut 20 and configured for compressive loading by the nut 20. The lip 36 may extend away from the floor 35, forming a cylindrical wall joined along one edge to the floor 35. The lip 36 and floor 35 may define a seat into which nut 20 may nest. In various embodiments the lip 36 extends forward of the floor according to the definition of forward introduced herein.

Washer 30 may include an edge ring 34. Edge ring 34 may be an outer edge of the washer 30 configured to selectably mechanically connect to the cap 40. For instance, the edge ring 34 may comprise a threaded aspect, such as an outward threaded face 38, threadably connectable to the cap 40.

The edge ring 34 may comprise a raised circumferential flange 37. The raised circumferential flange 37 may be cylindrical and may be circumferentially about the outward edge of the washer. Thus the edge ring 34 may extend forwardly away from the main washer body 31. For instance, a main washer body 31 may lie in a plane normal to the central longitudinal axis 101. The edge ring 34 may comprise a cylinder section that may extend along the longitudinal axis forward of the outer edge of the washer 30. Stated differently, the raised circumferential flange 37 may encircle the central longitudinal axis 101 and extend in the direction of a normal axis of the main washer body 31. In various instances, the circumferential flange 37 is integrally formed of a same piece of material with the main washer body 31.

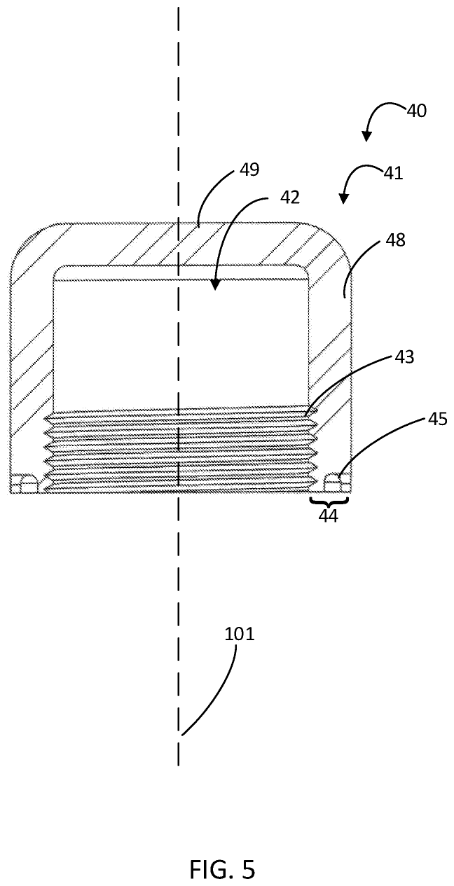

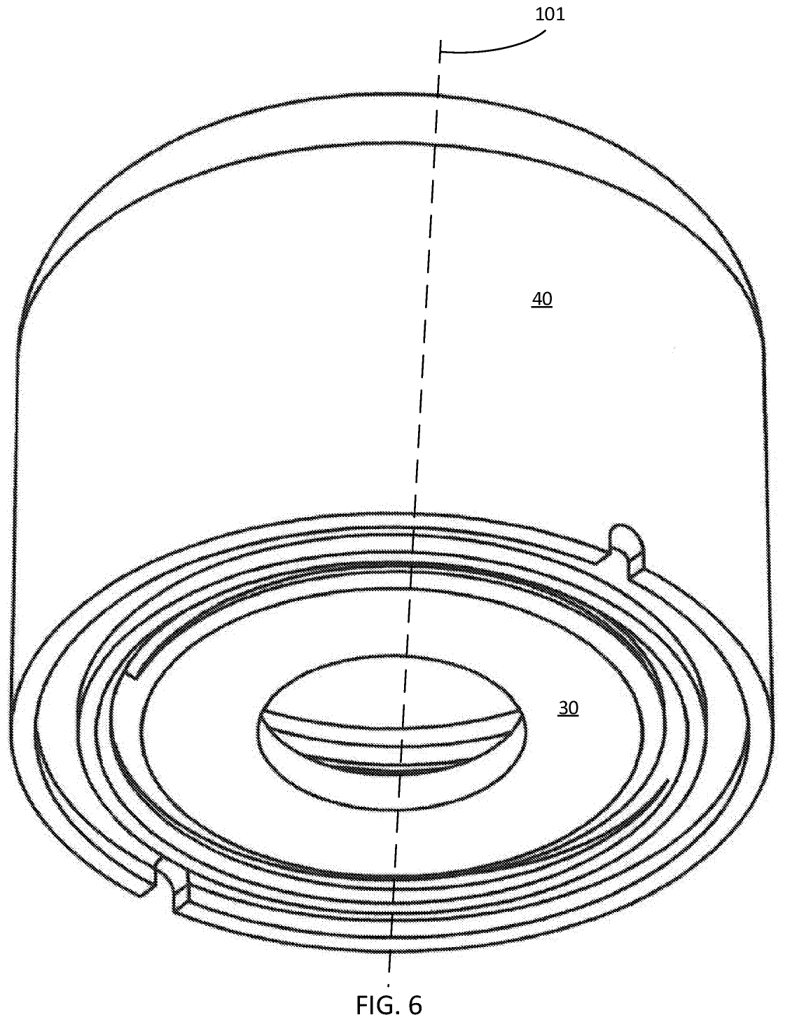

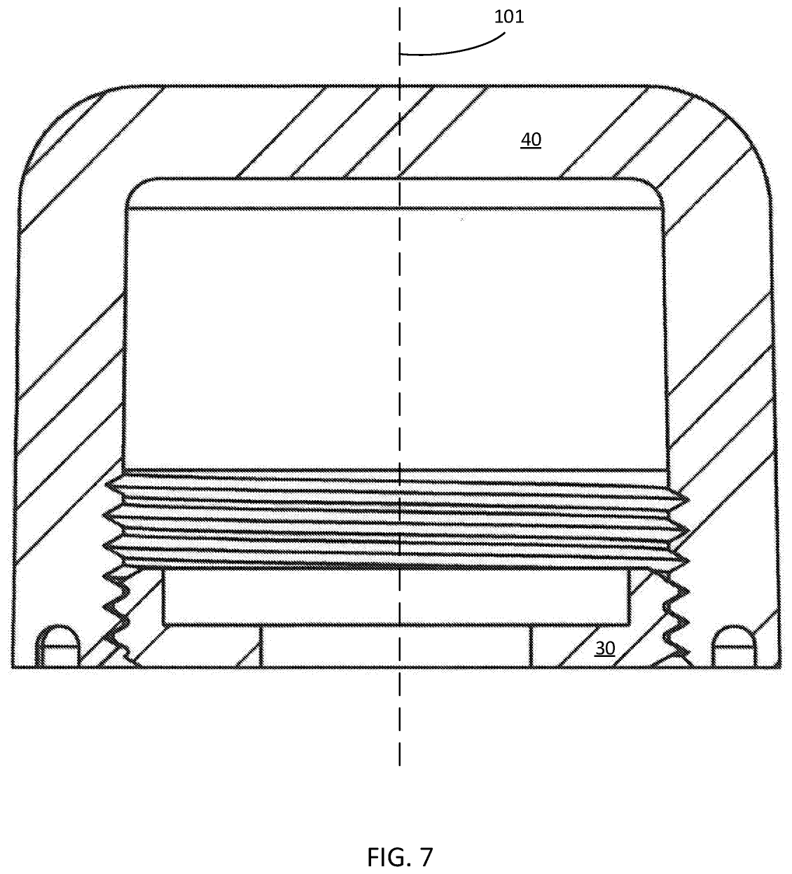

The edge ring 34 may comprise an outward threaded face 38. The outward threaded face 38 may be a radially outermost face of the edge ring 34 relative to the central longitudinal axis 101. The outward threaded face 38 may comprise outward facing threads extending outwardly from the edge ring 34 relative to the central longitudinal axis 101. In various embodiments, the outward threaded face 38 comprises threads structured to receive corresponding threads of an inner threaded face 43 of a cap 40 (See FIGS. 2, 5-7). In this manner, and with momentary reference to FIGS. 6 and 7, a washer 30 may be threadably joined to a cap 40 and may be received at least partially into the cap 40.

With renewed reference to FIGS. 1, 2, and 4, in further instances, the edge ring 34 comprises a localized thickening of the main washer body 31. Thus, while depicted as a cylindrical flange disposed circumferentially about the outward edge of the washer 30, in further instances, the edge ring 34 may extend from a face of the main washer body 31 (rather than an edge of the main washer body 31).

Thus, it may be said that a washer 30 may comprise an annular main washer body 31 and a cylindrical edge ring 34 comprising a circumferential flange 37 extending longitudinally from an outward edge of the main washer body 31.

Shifting focus to the combination of FIG. 1 and FIGS. 2, and 5, the cap 40 is now discussed in further detail. A cap 40 comprises a covering member open on one face to connect to the washer 30 and otherwise closed to protect at least a portion of the washer 30, a nut 20, and a bolt 10. For instance, a cap 40 may be attached to a washer 30 so that a portion of the bolt 10 and a nut 20 are inside a cavity of the cap 40 and the washer 30 closes the cavity.

A cap 40 may comprise a primary member 41. A primary member 41 may comprise a main body of the cap 40. In various embodiments, a primary member 41 comprises a cylinder with an open end. In further embodiments, a primary member 41 comprises any other shape as desired. As shown herein, a primary member 41 may comprise a wall member 48 and a floor member 49. The wall member 48 may comprise a cylindrical flange, and a floor member 49 may comprise a closure of one end of the cylindrical flange. In this manner, a cylinder with an open end may be formed.

A cap 40 may define an inner cavity 42. An inner cavity 42 may comprise a space defined by the wall member 48 and the floor member 49 and configured to receive a portion of a bolt 10 and a nut 20 and to be enclosed at an open end by the washer 30.

A cap 40 may include an inner threaded face 43. The inner threaded face 43 may comprise a radially inwardly facing threaded surface of the wall member 48 of the cap 40 configured to receive the threads of the outward threaded face 38 of the washer 30. For instance, the inner threaded face 43 of the cap 40 may comprise an inward surface of the primary member 41. More specifically, the inner threaded face 43 of the cap 40 may comprise an inward surface of the wall member 48 of the cap 40. The inner threaded face 43 of the cap 40 may comprise an inward surface of the wall member 48 of the cap 40 positioned opposite the floor member 49 along a central longitudinal axis 101 and configured to receive corresponding threads of an outward threaded face 38 of the edge ring 34 of the washer 30.

A cap 40 may include a contact edge 44. A contact edge 44 may comprise an edge of the primary member 41, and specifically, an edge of the wall member 48 opposite the floor member 49 and configured to contact an article being joined by the bolt 10, nut 20, and washer 30. For instance, as the cap 40 threadably joins to the washer 30, the contact edge 44 may contact an article being joined by the bolt 10, nut 20, and washer 30 and may exert an interference fit, pressing against the article. In various embodiments, the contact edge 44 comprise an edge of the primary member 41 lying in a normal plane of the central longitudinal axis 101 and comprising a distal most edge of wall member 48 of the primary member 41, opposite the floor member 49.

In various embodiments, the contact edge 44 comprises an edge channel 45. An edge channel 45 may comprise an annular groove defined in a face of the contact edge 44, forming a channel. In various embodiments, the edge channel 45 facilitates flexure of the contact edge 44, facilitating compressive loading to ameliorate unscrewing of the cap 40. In further instances, the edge channel 45 is configured to receive a compressible O-ring, for example, to effectuate a fluid seal of the inner cavity 42 and ameliorate fluid ingress and subsequent corrosion and/or rust of the bolt 10, nut 20, and/or washer 30.

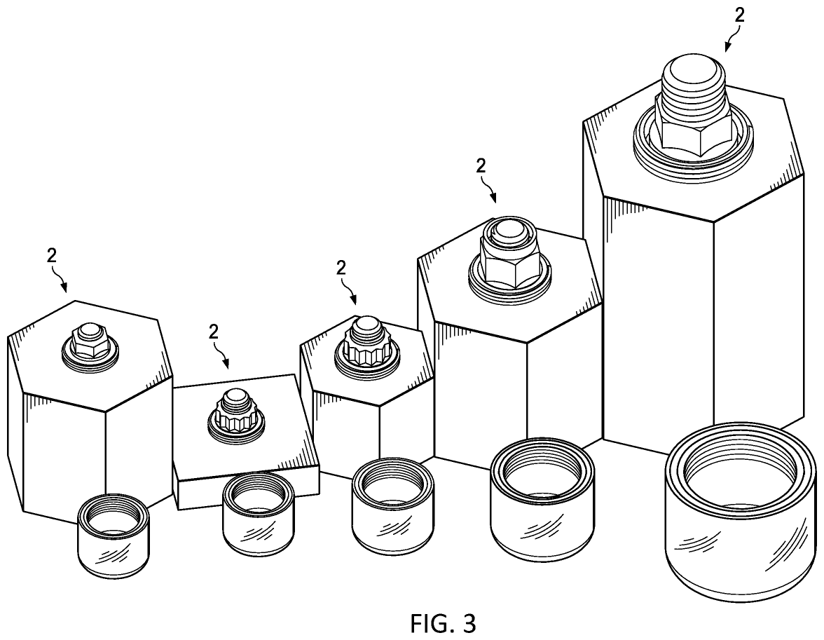

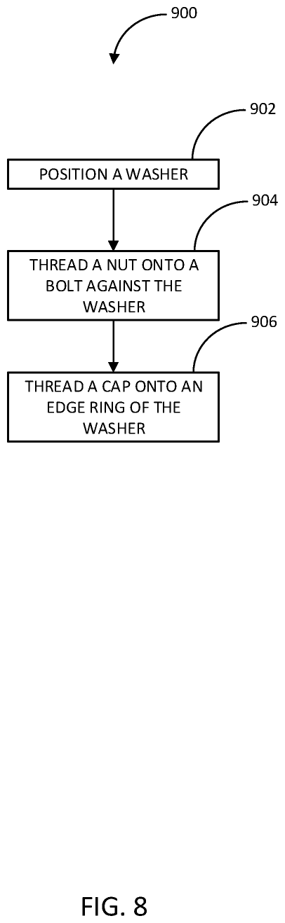

With reference to FIGS. 1-7 but with particular emphasis on FIG. 8, a method 900 of using a fastening system 2 is provided. In various embodiments, a washer 30 may be positioned annularly encircling at least a portion of a bolt 10 (block 902). A nut 20 may be threaded onto the bolt 10 and tightened against the washer 30 (block 904). A cap 40 may be threaded onto an edge ring 34 of the washer 30, the edge ring 34 comprising an outward threaded face 38 corresponding to an inner threaded face 43 of a wall member 48 of a primary member 41 of the cap 40 (block 906). In this manner, the cap 40 may be affixed over at least one of the nut 20 and the bolt 10 and may ameliorate environmental exposure thereof.

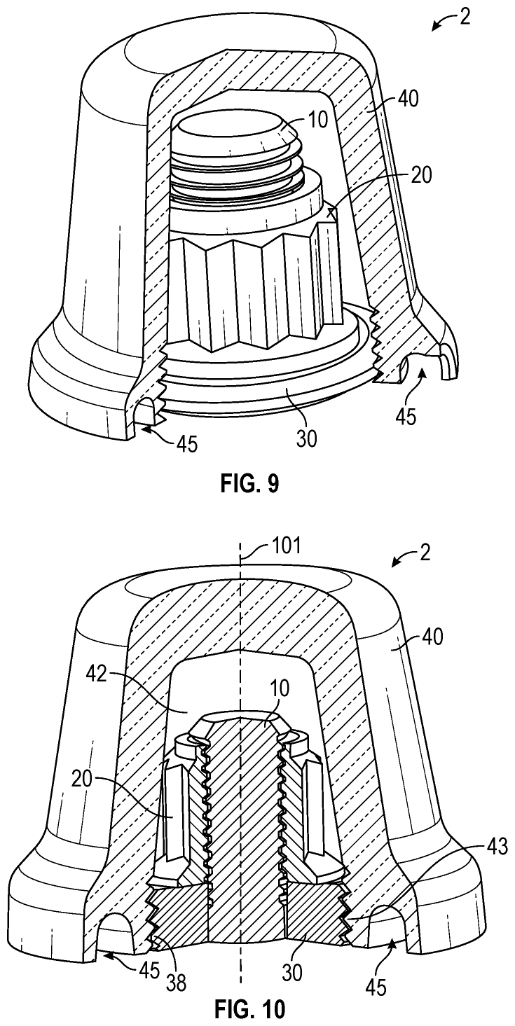

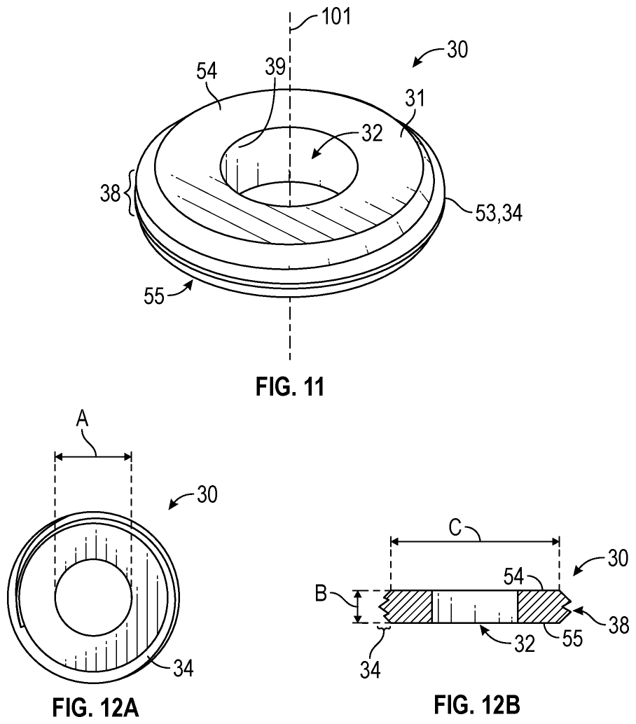

With reference to FIGS. 9 and 10, a fastening system 2 is provided, according to another exemplary embodiment. The fastening system 2 comprises a combination of fastening elements configured to join at least two articles together. The fastening system 2 may include a bolt 10 and a nut 20 that can thread onto a threaded portion of the bolt 10, sandwiching articles to be joined along the length of the bolt 10.

The fastening system 2 may include a washer 30. The washer 30 may be placed between the nut 20 and an article being loaded in compression by the combination of bolt 10 and nut 20. The washer 30 may increase the contact area of the nut 20 in conjunction with the article. The fastening system 2 may also include a cap 40. The cap 40 may comprise a protective aspect. For instance, the cap 40 may define a cavity sized to receive at least a portion of a nut 20 and or bolt 10 and may be joinable to the washer 30. For instance, the cap 40 may be closed on all but one size, and the one open side may be threadably connectable to the washer 30, wherein the internal cavity of the cap 40 is closed. As such, the washer 30 may be attachable to the cap 40 configured to enclose at least a portion of a nut 20 and/or bolt 10.

A shared central longitudinal axis 101 may align with a center of an aperture of the nut 20 and/or the central axis of the bolt 10, and/or a center of an aperture of the washer 30, and may extend longitudinally through the center of the bolt 10, nut 20, washer 30, and cap 40.

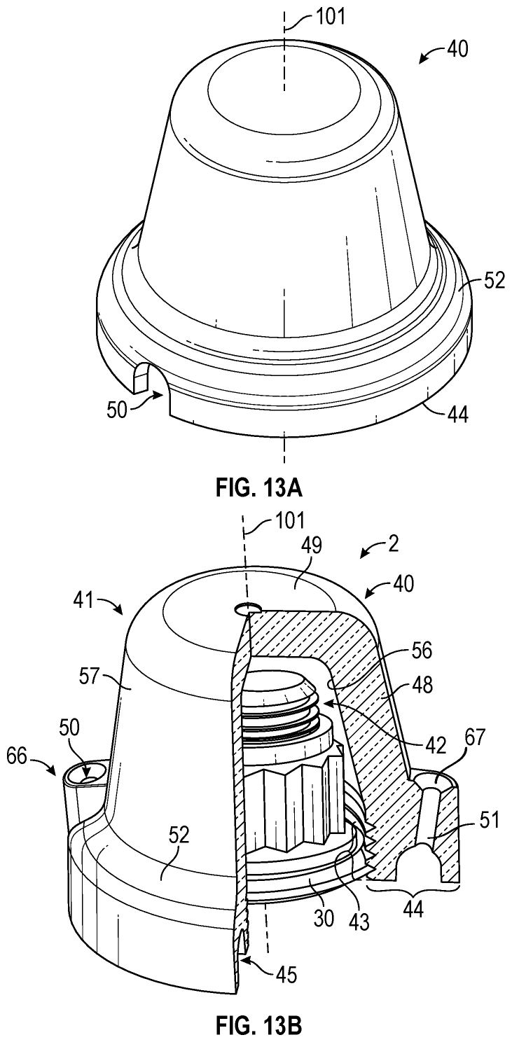

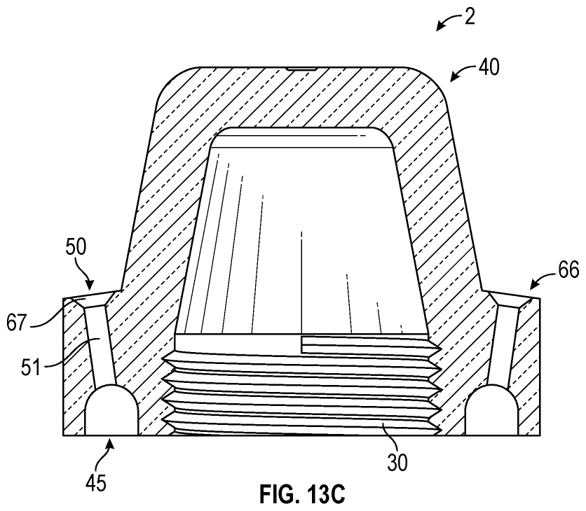

Turning now to FIGS. 11-12B, specific aspects of the washer 30 are now introduced. A washer 30 may comprise an annular member compressible between a nut 20 and an object joined in compressive loading to the combination of nut 20 and bolt 10. The washer 30 may be an annulus, or in further embodiments, may have different shapes as desired.

Washer 30 may include a main washer body 31. The main washer body 31 may comprise an annular plate, for instance, resembling a flat donut, though further shapes may be contemplated. A fastener channel 32 may comprise an aperture defined through the main washer body 31. In various instances, the fastener channel 32 is aligned centered on a central longitudinal axis 101 during use, the central longitudinal axis 101 extending normal to the main washer body 31 through a center of the fastener channel 32. Thus, one may say that the main washer body 31 comprises an annular plate defining an encircled aperture (fastener channel 32) and extending radially outward to an outward edge (e.g., extending to edge ring 34).

Washer 30 may include an edge ring 34. Edge ring 34 may be an outer edge of the washer 30 configured to selectably mechanically connect to the cap 40. For instance, the edge ring 34 may comprise a threaded aspect, such as an outward threaded face 38, threadably connectable to the cap 40. The outward threaded face 38 may be a radially outermost face of the edge ring 34 relative to the central longitudinal axis 101. The outward threaded face 38 may comprise outward facing threads extending outwardly from the edge ring 34 relative to the central longitudinal axis 101. In various embodiments, the outward threaded face 38 comprises threads structured to receive corresponding threads of an inner threaded face 43 of a cap 40 (See at least FIGS. 9 and 10). In this manner, the washer 30 may be threadably joined to the cap 40 and may be received at least partially into the cap 40. In some instances, the washer 30 may include a coincident circumferential flange 53 coincident with the edge ring 34. Unlike the circumferential flange 37 (FIG. 4), the coincident circumferential flange 53 does not extend longitudinally from an outward edge of the main washer body 31, but is coincident therewith. In various embodiments, the coincident circumferential flange 53 comprises a portion of the edge ring 34 that is the outward threaded face 38. As such, one may say that the coincident circumferential flange 53 is an aspect of (or coincident with) the threading.

The main washer body 31 of the washer 30 as described in FIGS. 9-12B may have a first surface 54 and a second surface 55 opposite the first surface 54. The first and second surfaces 54, 55 may be flat, continuous surfaces extending from the edge ring 34 to the fastener channel 32. In further embodiments, one or more of the first surface 54 and the second surface 55 may be curved, such as being concave (e.g., progressively retreating from contact with an adjacent article nearer to the fastener channel) or such as being convex (e.g., progressively advancing toward contact with an adjacent article nearer to the fastener channel). In this manner, reaction forces associated with loading of the washer in compression may be tailored to different applications. Further the fastener channel may be a smooth continuous surface extending between the first and second surfaces 54, 55. For instance, the fastener channel may define a cylindrical aperture, or an aperture of any other shape, forming a passage through the main washer body 31 of the washer 30 and connecting the first surface 54 and the second surface 55. In other words, the washer 30 as described in FIGS. 9-12B does not include the counterbore disposed in the center of the washer (e.g., the circumferential flange 37 does not extend longitudinally nor provide a cavity in the washer defined by a floor 35 and a lip 36 (see and compare FIG. 4)) as described in the washer embodiment of FIGS. 2 and 4, for instance.

Thus, a main washer body 31 has a plate defining an encircled aperture and extending radially outward to a threaded outward edge. The threaded outward edge may be an outward threaded face 38 of an edge ring 34, such portion of the edge ring 34 that is the outward threaded face 38 may also be coincident circumferential flange 53.

As shown in FIGS. 12A-12B, the fastener channel 32 has a diameter A the washer 30 has a height B (e.g., the distance between the first surface and the second surface), and the edge ring 34 has a diameter C (e.g., the distance across the main washer body 31), with the outward threaded face 38 having threads extending outward of diameter C. As inclusive examples, which one of ordinary skill in the art would understand to be non-limiting, A2 may range from 0.438-0.449 or 0.251-0.261. B may range from 0.089-0.101 or 0.103-0.115. C may range from 0.790-0.940 (e.g., 0.938, 0.5553-0.5625, 0.8669-0.8750, 0.493+/−0.003, or 0.795+/−0.003). In the embodiment of a washer 30 including a counterbore as described above with reference to FIGS. 2 and 4, C may be 0.765 and B is 0.164, wherein the section below the flange is 0.064-0.078. Other dimensions are contemplated, as may be desired for further applications. All dimensions described herein are in inches. For further examples, see Chart 1 below.

CHART 1

| A | B | C |
|---|---|---|
| ±.005 | ±.006 | MIN |
| .196 | .095 | .386 |
| .256 | .095 | .503 |
| .319 | .095 | .566 |
| .382 | .095 | .680 |
| .444 | .103 | .805 |

Shifting focus to the combination of FIGS. 9, 10, and 13A, the cap 40 is now discussed in further detail. The cap 40 comprises a covering member open on one face to connect to the washer 30 and otherwise closed to protect at least a portion of the washer 30, a nut 20, and a bolt 10. For instance, a cap 40 may be attached to a washer 30 so that a portion of the bolt 10 and a nut 20 are inside a cavity of the cap 40 and the washer 30 closes the cavity.

A cap 40 may comprise a primary member 41. A primary member 41 may comprise a main body of the cap 40. In various embodiments, a primary member 41 comprises a conic section with an open end. In various instances, the conic member presents cross-sections along the central longitudinal axis 101 comprising circles of varying radius. For instance, the conic member may present cross-sections along the central longitudinal axis 101 comprising circles of increasing radius nearer to the open end. In various embodiments, such a configuration presents a contrast to the constant radius cylinder of the cylindrical primary member described with reference to FIGS. 1, 2 and 4, for instance. One may appreciate that by implementing conic structures, one may exploit an improved resiliency, strength, etc. associated with triangular structures (including triangle sections revolved about an axis, such as a conic section may represent) in contrast to trapezoidal structures (including trapezoid sections revolved about an axis, such as a cylinder section may represent). In further embodiments, a primary member 41 comprises any other shape as desired.

As shown herein, a primary member 41 may comprise a wall member 48 and a floor member 49. The wall member 48 and the floor member 49 may meet to form a closure on one end of the primary member 41. In this manner, a conical section with an open end may be formed. The cap 40 may thus defines an inner cavity 42. An inner cavity 42 may comprise a space defined by the wall member 48 and the floor member 49 and configured to receive a portion of a bolt 10 and a nut 20 and to be enclosed at an open end by the washer 30.

The cap 40 may further include a skirt 52. A skirt 52 may comprise a local thickening of the cap 40 adjacent to the primary member 41. The skirt may comprise a local thickening of the primary member 41. The skirt may be formed of a same piece of material with the primary member 41 and may be continuous with the primary member 41. In various embodiments, the skirt may be adjacent to the primary member 41. The skirt may be attachable in physical communication with the primary member 41.

In various embodiments, a distance between an inward face (e.g., a face closer to the central longitudinal axis and disposed at least partially about the central longitudinal axis) and an outward face (e.g., a face farther from the central longitudinal axis and disposed at least partially about the central longitudinal axis) of the skirt may vary at stations along the central longitudinal axis. For instance, the distance between the inward face and the outward face may increase at stations approaching nearer to the edge channel 45 along the central longitudinal axis.

As contemplated above, the skirt 52 may be disposed on the open end of the primary member 41. More specifically, from a top view (e.g., a plane perpendicular to the central longitudinal axis 101), the floor member 49 may be circular. The wall member 48 may radially extend outward from the floor member 49, and from the floor member 49 to the skirt 52, such that a first end of the wall member 48 corresponding with the closed end of the primary member 41 has a smaller diameter than a diameter of a second end of the wall member which meets the skirt 52 at the open end of the primary member 41. The wall member 48 may correspond with cross-sections along the central longitudinal axis of the conic section comprising circles of increasing radius nearer and near to the open end. Thus, the wall member 48 may comprise a conic section joining the floor member 49 at an angle. The angle may be greater than 90 degrees, in contrast to that of a cylindrical cap 40 (see FIGS. 1, 2, and 4).

An outer diameter of the skirt 52 may similarly be larger than the diameter of the second end of the wall member 48 such that the skirt 52 extends radially outward from the wall member 48 but with differing radius at stations along the longitudinal axis, thus forming a shoulder to the primary member 41. In various instances, the skirt 52 presents cross-sections along the central longitudinal axis 101 comprising circles of varying radius. For instance, the skirt 52 may present cross-sections along the central longitudinal axis 101 comprising circles of increasing radius nearer and near to a contact edge 44. In various instances, the cross-sections may only increase for a first portion and transition to a constant radius for a second portion (e.g., along the height of an edge channel 45). As mentioned, the thickness of the skirt may also vary, so that a cross-section may have an annular shape, the annulus varying in thickness at different stations along the central longitudinal axis.

The wall member 48 may have an inner surface 56 and an outer surface 57. The outer surface 57 may appear conical from the floor member 49 to the skirt 52 (e.g., an inclined plane section). On the other hand, the inner surface 56 may straighten out for the distance of the skirt 52. For instance, the inner surface 56 and the outer surface 57 may present cross-sections along the central longitudinal axis 101 comprising circles of varying radius. For instance, the skirt 52 may present cross-sections along the central longitudinal axis 101 comprising circles of increasing radius nearer and near to the skirt 52. Along the length of the skirt 52, specifically the second portion, the radius of the inner surface 56 may cease increasing and be at least partially parallel to the central longitudinal axis 101. As such, the straightened inner surface may include an inner threaded face 43. The inner threaded face 43 may comprise a radially inwardly facing threaded surface of the wall member 48 of the cap 40 configured to receive the threads of the outward threaded face 38 of the washer 30. For instance, the inner threaded face 43 of the cap 40 may comprise an inward surface of the primary member 41.

A cap 40 may include a contact edge 44. A contact edge 44 may comprise an edge of the primary member 41, specifically, an edge of the wall member 48 opposite the floor member 49 and an edge of the skirt 52, and configured to contact an article being joined by the bolt 10, nut 20, and washer 30. For instance, as the cap 40 threadably joins to the washer 30, the contact edge 44 may contact an article being joined by the bolt 10, nut 20, and washer 30 and may exert an interference fit, pressing against the article. In various embodiments, the contact edge 44 comprises an edge of the primary member 41 lying in a normal plane of the central longitudinal axis 101, and comprising an edge of the skirt 52. Stated differently, the contact edge 44 comprises an annular face of the skirt 52 configured to contact an article being joined by the bolt 10, nut 20, and washer 30.

As described herein, the skirt 52 forms a shoulder to the primary member 41. The area within the skirt 52 changes at stations along the central longitudinal axis 101, from the wall member 48 to the bottom of the cap 40 (e.g., the contact edge 44). In some instances, the area within the skirt 52 increases (e.g., the skirt widens or thickens). As such, beneficially, the skirt 52 may be configured to widen and/or thicken to house an edge channel 45. In various embodiments, the contact edge 44 comprises the edge channel 45. An edge channel 45 may comprise an annular groove defined in a face of the contact edge 44, forming a channel within the skirt 52. The skirt 52 includes an inner surface that may be considered relatively straight with the inner threaded face 43, and an outer surface which arches around the edge channel 45 providing adequate structural material both radially inward and radially outward of the edge channel 45. As described herein, the skirt 52 presents cross-sections along the central longitudinal axis 101 comprising circles of varying radius. As such, the outer surface of the skirt 52 may present cross-sections along the central longitudinal axis 101 comprising circles of increasing radius nearer to a contact edge 44. Again, in various instances, the cross-sections may only increase for a first portion and transition to a constant radius for a second portion (e.g., along the height of an edge channel 45). The inner surface of the skirt 52 may have a constant radius throughout its height extending along the longitudinal axis 101. Thus, the outer surface of the skirt 52 may similarly straighten to be parallel to the portion of the inner surface of the skirt 52 forming the edge channel 45. In various embodiments, a radius of cross-sections of the inner surface of the skirt 52 may increase toward the contact edge 44 at a constant slope. In various embodiments, a radius of cross-sections of a first portion of the inner surface of the skirt 52 farther from the contact edge 44 may increase toward the contact edge 44 at a constant slope and a radius of cross-sections of a second portion of the inner surface of the skirt 52 nearer to the contact edge 44 may increase toward the contact edge 44 at a different constant slope. In yet further embodiments, a radius of cross-sections of a first portion of the inner surface of the skirt 52 farther from the contact edge 44 may increase toward the contact edge 44 at a constant slope and a radius of cross-sections of a second portion of the inner surface of the skirt 52 nearer to the contact edge 44 may be constant, not increasing toward the contact edge 44.

In various embodiments, the edge channel 45 facilitates flexure of the contact edge 44, facilitating compressive loading to ameliorate unscrewing of the cap 40. In further instances, the edge channel 45 is configured to receive a compressible O-ring, for example, to effectuate a fluid seal of the inner cavity 42 and ameliorate fluid ingress and subsequent corrosion and/or rust of the bolt 10, nut 20, and/or washer 30. In further instances, the edge channel 45 is configured to receive an injectable sealant, for instance, to be injected into the edge channel 45 after installation of the cap 40 over the bolt 10, nut 20, and/or washer 30, such as to effectuate a fluid seal of the inner cavity 42 and ameliorate fluid ingress and subsequent corrosion and/or rust of the bolt 10, nut 20, and/or washer 30, or fluid leakage through associated openings. The injectable sealant may be injected into the edge channel 45 via an aperture 50. The aperture 50 is disposed along an outer surface of the skirt 52. In various embodiments, the aperture 50 may open upwardly in a direction generally parallel to the central longitudinal axis 101. In various embodiments, the aperture 50 may open radially in a direction generally perpendicular to the central longitudinal axis 101 and/or generally parallel to a radius line extending perpendicularly from the central longitudinal axis 101.

Thus, a primary member has a wall member and a floor member defining a conic section with an open end. A skirt is disposed along the open end of the primary member, and an inner threaded face having a radially inward face of the wall member is configured to receive the threads of an outward threaded face of a washer.

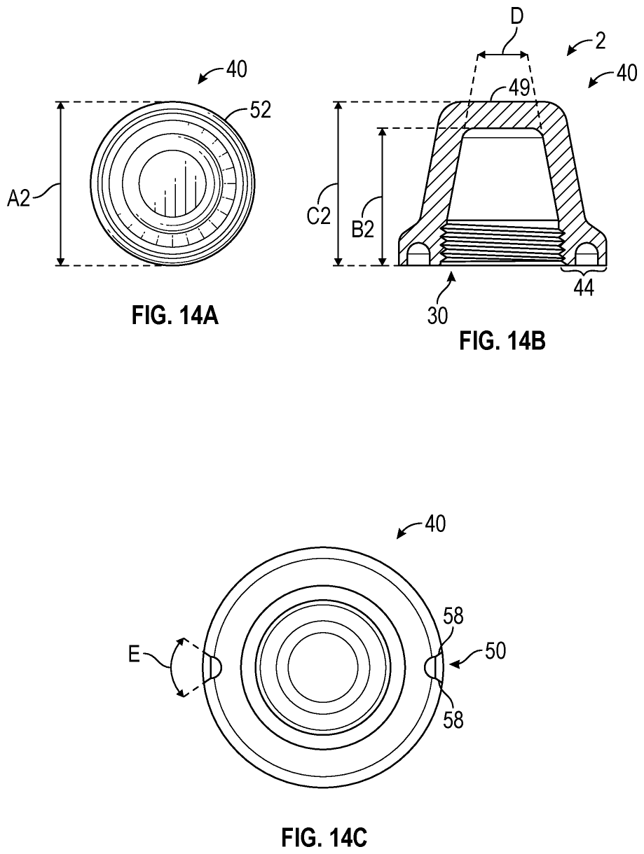

As shown in FIGS. 13B and 13C, an aperture 50 may be disposed on an upper surface of the skirt 52 such that the aperture 50 extends radially outward and faces open along the central longitudinal axis 101. For instance, the aperture 50 may be disposed on a fill port stub 66. The aperture 50 is defined into the fill port stub 66 and is in fluid connection with a through channel 51. The through channel 51 is configured to connect the aperture 50 to the edge channel 45 such that the through channel 51 extends between the aperture 55 and the edge channel 45, and is in fluid connection with the edge channel 45. For instance, a sealant may be inserted in at the aperture 50 and fill the edge channel 45 via the through channel 51. Thus, the aperture 50 may be accessible by a user positioned above the cap 40. Depending on how and when a sealant may be inserted (e.g., pumped) into the edge channel 45, the aperture 50 as shown in FIG. 13A may create a difficult angle for a user to access, such as requiring access along a path generally radial to the longitudinal axis. The aperture 50 as shown in FIGS. 13B and 13C allows the user to use a tool orientation to insert the sealant that is similar to the orientation of the tool to tighten the fastening system and generally along a same axis. For example, a fastener driver could be inserted along an axis generally parallel to the longitudinal axis and similarly, and a sealant dispensing device could be inserted along a similar axis. As such, the fill port stub 66 may include a conic shelf 67 configured to selectably interface with a filling tool.

To further illustrate this configuration, reference is now made to FIG. XX. The fastening system 2, may be used inside a fuel tank of an aircraft, such as a section of a fuel tank inside a wing. The fastening system 2 is configured to seal the fuel from exiting the tank. Thus the fastening system 2 ameliorates leakage and/or fluidic communication between content of the fuel tank (or other environment) and adjacent structures. In this manner, the fastening system ameliorates exposure of surrounding components to content of the fuel tank, which may be undesirable or deleterious. The novel two-piece assembly with internally threaded component provides safe and clean environmental protection for the aircraft.

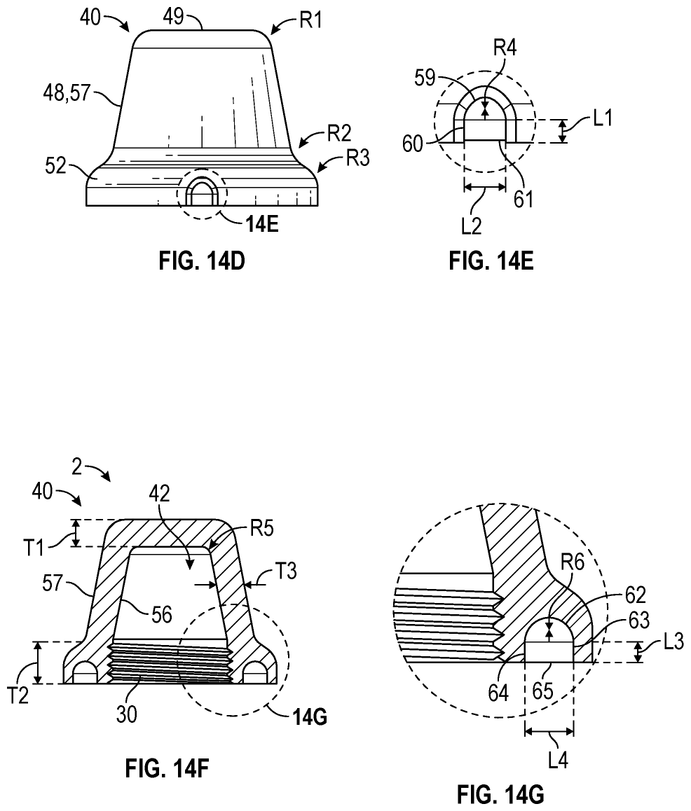

As shown in FIGS. 14A-14C, the largest part of the skirt 52 has a diameter A2, the cap 40 from its open end to the top of the inner cavity has a height B2 (e.g., from the contact edge 44 to an inner surface of the floor member 49), the cap 40 has a height C2 (e.g., from the contact edge 44 to an outer surface of the floor member 49), the inner cavity 42 has a diameter D (e.g., inner surface of the floor member), and the aperture 50 has an angle E. Angle E defines the angle made by the side surfaces 58 of the aperture 50. As inclusive examples, which one of ordinary skill in the art would understand to be non-limiting, A may range from 0.980-0.1.340 (e.g., 0.994+/−0.005 or 1.330+/−0.005), B may range from 0.020-0.645 (e.g., 0.639+/−0.005 or 0.025+/−0.005). C may range from 0.755-1.1 (e.g., 0.764+/−0.005 or 1.05+/−0.005). D may range from 0.36-0.67 (e.g., 0.365+/−0.003, 0.665+/−0.005). All dimensions described herein are in inches. E may range from 50-120 degrees (e.g., 66, 89.4, or 114.7 degrees). For further examples, see Chart 2 below.

CHART 2

| A | B | C | D |
|---|---|---|---|
| MAX | MIN | MAX | MIN |
| .941 | .468 | .603 | .267 |
| .999 | .634 | .769 | .362 |
| 1.134 | .694 | .829 | .432 |
| 1.279 | .789 | .924 | .507 |
| 1.335 | .920 | 1.055 | 1.047 |

Referring now to FIGS. 14D-14, dimensions of the cap 40 are illustrated. As shown in FIG. 14D, R1 is a radius of a curved edge along the outer edge of the floor member 49 (e.g, a concave surface connecting the outer surface of the floor member 49 to the outer surface 57 of the wall member 48), R2 is a radius of a curved edge along the wall member 48 where the wall member 48 meets the skirt 52 (e.g., a convex surface connecting the outer surface of the floor member 49 to the outer surface of the skirt 52), and R3 is a radius of a curved edge along the skirt 52 (e.g., a concave surface rounding out the shoulder of the skirt 52 where the cross-sections cease increasing on the first portion and transition to a constant radius for the second portion of the skirt 52). As shown in FIG. 14E, Detail A of FIG. 14D, R4 is a radius of a top arch 59 of the aperture 50 and L1 is the height of a side surface 60 of the aperture 50. Thus, the total height of the aperture 50 is L1+R4. Further, L2 is the width of the aperture 50 along a floor surface 61 defined by the distance between the side surfaces 60.

As shown in FIG. 14F, R5 is the radius of a curved edge along the inner surface of the floor member 49 (e.g., a convex surface connecting the inner surface of the floor member to the inner surface 56 of the wall member 48 within the inner cavity 42). Further, T1 is the thickness of the top portion of the cap 40 (e.g., the distance between the outer surface and the inner surface of the floor member 49), T2 is the thickness of the inner threaded face 43 (e.g., the portion of the inner surface 56 that may straighten out for the distance of the skirt 52), and T3 is the thickness of the wall member 48 (e.g., the distance from the inner surface 56 to the outer surface 57). As shown in FIG. 14G, Detail B of FIG. 14F, R6 is the radius of a top arch 62 of the edge channel 45 and L3 is the height of a side surface 63, 64 of the edge channel 45. Thus, the total height of the edge channel 45 is L3+R6. Further, L4 is the width of the edge channel 45 along a floor surface 65 defined by the distance between the side surfaces 63, 64. The top arch 62 and the side surfaces 63, 64 are bound by the internal structure of the skirt 52. T4 is the thickness of a portion of the skirt 52 forming the exterior portion of the edge channel 45 (e.g., the distance from the outer side surface 63 of the edge channel 45 to the outer surface of the skirt 52).

As inclusive examples, which one of ordinary skill in the art would understand to be non-limiting, R1 may be 100+/−0.005, R2 may be 0.045+/−0.005, R3 may be 0.05+/−0.003 or +/−0.005, and R4 may be 0.055+/−0.003. As inclusive examples, which one of ordinary skill in the art would understand to be non-limiting, L1 may be 0.05+/−0.005 or +/−0.006, L2 may be 0.09+/−0.005, L3 may be 0.050+/−0.005, and L4 may be 0.113+/−0.005. As inclusive examples, which one of ordinary skill in the art would understand to be non-limiting T1 may be 0.125+/−0.005, T2 may be 0.210 or 0.305, T3 may be 0.125+/0.005, and T4 may range from 0.042-0.05. All dimensions described herein are in inches.

With reference to FIGS. 1-14G, having discussed aspects of a fastening system 2, a fastening system 2, and/or its component washer 30 and/or cap 40 may be made of various materials. For instance, a fastening system 2, and/or its component washer 30 and/or cap 40 may be made of a single material, or different materials, or combinations of materials. For example, components of the system are made from metal. For example, aspects of a fastening system 2, and/or its component washer 30 and/or cap 40 are metal, such as nickel, cobalt, molybdenum, titanium, aluminum, steel, or stainless steel, though it alternatively comprises numerous other materials configured to provide support. Components of the system are optionally made from other materials such as, for example, composite, ceramic, plastics, polymers, alloys, glass, binder, epoxy, polyester, acrylic, or any material or combination of materials having desired material properties, such as heat tolerance, strength, stiffness, or weight. In various instances the cap 40 is transparent.

Portions of a fastening system 2, and/or its component washer 30 and/or cap 40 as disclosed herein are optionally made of different materials or combinations of materials, and/or comprise coatings. Moreover, components of the fastening system 2, and/or its component washer 30 and/or cap 40 are in some instances mixtures of different materials according to different ratios, gradients, and the like.

A fastening system 2, and/or its component washer 30 and/or cap 40 thus may have multiple materials, or any material configuration suitable to enhance or reinforce the resiliency and/or support of the system when subjected to wear in an operating environment such as an aircraft operating environment, or to satisfy other desired electromagnetic, chemical, physical, or material properties, for example coefficient of thermal expansion, ductility, weight, flexibility, strength, or heat tolerance.

One such material is Trogamid. In various embodiments, a fastening system 2, and/or its component washer 30 and/or cap 40 may comprise Trogamid, such as Trogamid CX7323 polyamide. In various embodiments, a fastening system 2, and/or its component washer 30 and/or cap 40 may comprise cadmium plate. The fastening system 2, and/or its component washer 30 and/or cap 40 may be passivated.

Further such material may be an austenitic nickel-chromium-based alloy such as Inconel®, which is available from Special Metals Corporation of New Hartford, N.Y., USA. Other such material includes ceramic matrix composite (CMC). Further material includes refractory metal, for example, an alloy of titanium, such as, titanium-zirconium-molybdenum (TZM).

Various benefits and advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A washer comprising:
a main washer body comprising a plate defining an encircled aperture and extending radially outward to an outward edge, the main washer body having a first surface and a second surface opposite the first surface such that the encircled aperture extends continuously from the first surface to the second surface;
an edge ring disposed about the outward edge of the washer and comprising an outward threaded face; and
wherein the outward threaded face comprises a face of the edge ring and comprises threads configured to receive corresponding threads of an inner threaded face of a cap.

2. The washer according to claim 1, wherein the first surface is continuous in a first plane and the second surface is continuous in a second plane spaced apart from and parallel to the first plane.

3. The washer according to claim 1,
wherein the main washer body does not include a counterbore in the first surface,
wherein the main washer body does not include a counterbore in the second surface.

4. The washer according to claim 1, wherein the first surface is continuous in a first plane and the second surface is continuous in a second plane spaced apart from and parallel to the first plane, wherein both the first plane and the second plane are flat planes.

5. The washer according to claim 1, wherein the first surface is continuous in a first plane and the second surface is continuous in a second plane, wherein the first plane is one of concave and convex.

6. The washer according to claim 5, wherein the second plane is one of concave and convex.

7. The washer according to claim 1, wherein the first surface is defined by a first continuous non-piecewise mathematic function and wherein the second surface is defined by a second continuous non-piecewise mathematic function.

8. The washer according to claim 7, wherein the first and second surfaces are parallel and spaced apart.

9. The washer according to claim 1, wherein the plate is annular.

10. The washer according to claim 1, wherein the face of the edge ring comprised of the outward threaded face is a radially outermost face of the edge ring relative to the central longitudinal axis.

11. The washer according to claim 1, wherein the encircled aperture is defined through a center of the main washer body.

12. The washer according to claim 1, wherein the washer is threadably joinable to the cap and at least partially received into the cap.

13. A cap comprising:
a primary member comprising a wall member and a floor member defining a conic section with an open end;
a skirt disposed adjacent the open end of the primary member; and
an inner threaded face comprising a radially inward face of at least one of the skirt and the wall member and configured to receive the threads of an outward threaded face of a washer.

14. The cap according to claim 13, wherein the primary member has a first diameter and the skirt has a second diameter larger than the first diameter.

15. The cap according to claim 13, further comprising a contact edge comprising an edge of the wall member of the primary member positioned opposite the floor member and configured to contact an article being joined by a combination of a nut and a bolt, wherein the cap at least partially encloses the nut.

16. The cap according to claim 15, wherein the contact edge comprises an edge channel, the edge channel comprising an annular groove defined in a face of the contact edge and forming a channel.

17. The cap according to claim 16, wherein the skirt houses the edge channel.

18. The cap according to claim 13, further comprising an aperture defined through the skirt, such that the aperture faces radially outward from the skirt and opens into the skirt parallel to a longitudinal axis of the cap.

19. The cap according to claim 13, further comprising an aperture disposed on an upper surface of the skirt, such that the aperture extends radially outward and faces open along a longitudinal axis of the cap.

20. A fastening system comprising:
a washer comprising:
a main washer body comprising a plate defining an encircled aperture configured to receive a bolt and extending radially outward to an outward edge;
an edge ring disposed about the outward edge of the washer and comprising an outward threaded face; and
wherein the outward threaded face comprises a face of the edge ring and comprises threads; and
a cap comprising:
a primary member comprising a wall member and a floor member defining a conic section with an open end, such that the conic section defines a cavity;
a skirt disposed along the open end of the primary member;
an inner threaded face comprising a radially inward face of at least one of the wall member and the skirt and configured to receive corresponding threads of the outward threaded face of the washer; and
wherein the cap is configured to couple to the washer such that a portion of the bolt and a nut are inside the cavity of the cap and the washer at least partially closes the cavity.

21. The fastening system of claim 20, wherein the plate is annular.

22. The fastening system of claim 20, wherein the face of the edge ring comprised of the outward threaded face is a radially outermost face of the edge ring relative to the central longitudinal axis.

23. The fastening system of claim 20, wherein the encircled aperture is defined through a center of the main washer body.

24. The fastening system of claim 20, wherein the wall member has a first diameter and the skirt has a second diameter larger than the first diameter.

25. The fastening system of claim 20, further comprising (i) a contact edge of the skirt encircling the open end of the primary member and (ii) an edge channel, wherein the edge channel comprises an annular groove defined in a face of the contact edge and forming a channel.

26. The fastening system of claim 25, wherein the skirt houses the edge channel.

27. The fastening system of claim 26, further comprising an aperture disposed on the skirt and providing a fluid passage through the skirt to the edge channel.
